(19) United States
(12) Patent Application Publication
(10) Pub. No.: US 2009/0059250 A1
(43) Pub. Date: Mar. 5, 2009

(54) IMAGE PROCESSING SYSTEM, IMAGE FORMING APPARATUS, AND CONTROL METHOD THEREFOR

(75) Inventor: Akiko Onishi, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/187,828

(22) Filed: Aug. 7, 2008

(30) Foreign Application Priority Data
Aug. 29, 2007 (JP) 2007-223092

(51) Int. Cl. G06F 15/00; G06F 3/12

(52) U.S. Cl. 358/1.9; 358/1.13

(57) ABSTRACT

An image processing system having a document reading unit, a printing unit, and a generating unit configured to generate print data used to print by the printing unit, the system comprising: a grouping designation unit configured to group the print data; a storage unit configured to store a plurality of print data grouped by the grouping designation unit; and a specifying unit configured to specify target print data in the storage unit on the basis of a result of reading, by the document reading unit, a printing medium printed by the printing unit on the basis of at least one of the print data.

### BACKGROUND OF THE INVENTION

1. Field of the Invention

The present invention relates to an image processing system which performs repeat printing capable of printing print materials identical to those printed in the past, an image forming apparatus, and a control method therefor.

2. Description of the Related Art

Conventionally, when printing based on data created by various applications on a personal computer (PC), the user opens the print dialog of an application, designates a printer for use, and prints. At this time, the printer driver on the PC allows the user to make various print settings simultaneously when generating print data in a data format processible by the designated printer. For example, the user can set the type and size of printing medium, a color correction method, and the like, and select an image processing method corresponding to print data. The user can perform various image processes, trimming, and the like on an application for creating document data.

In most cases, it is difficult to re-obtain after a long time print materials that are identical to those obtained by changing processes using application functions and the print settings of the printer driver in various ways. This is because it is difficult for the user to perform a variety of processes using an application and complicated print settings in the printer driver similarly to previous printing. To solve this problem, there is a technique capable of easily printing out print materials identical to those printed in the past. For example, Japanese Patent Laid-Open No. 9-179704 discloses a function convenient for repeatedly outputting a document, which has been printed once, in the same state as that in previous printing. This function (to be referred to as a repeat print function hereinafter) saves print data in a storage device installed in the printer simultaneously when the printer prints based on received print data. When the printer later receives a request to output the print data again, the repeat print function outputs the print data saved in the storage device. The repeat print function allows the user to obtain identical print materials without activating an application, selecting and editing a document, and making print settings again on a printer driver window.

Japanese Patent Laid-Open No. 2003-001880 discloses a convenient function for designating data to be output again in repeat printing. This function uses print materials to specify data to be output again. More specifically, image data which has been bitmapped in printing, and identification information for specifying an image are stored in the memory. The identification information is printed on a print material (or another sheet). In repeat printing, the identification information of the print material is scanned to specify data in the memory, and an identical print material is output again based on the data. By a simple operation, the user can designate data used to output a print material again.

However, it is not always easy to select data the user wants, according to a method of displaying a list of saved print data and prompting the user to designate data to be output again, like the technique disclosed in Japanese Patent Laid-Open No. 9-179704. Especially when a fine image process was executed using an application function or when printing is done based on the same document data a plurality of number of times while changing the print settings of the printer driver in various ways, it is difficult to find out print data to be output again from a list of print data. According to the technique disclosed in Japanese Patent Laid-Open No. 2003-001880, the user can use a print material to designate data to be output again. However, repeat printing requires a print material which has already been output, and the user cannot execute repeat printing by a simple operation.

It is also possible to save only print data which is highly likely to undergo repeat printing, in order to designate target data by a simple operation even when the same document data is processed and repeatedly printed without using a print material in repeat printing. For example, there is a method of prompting the user to select whether to save print data for each print job. However, this method requires a cumbersome operation to make this selection every printing. There is another method of designating print data to be saved by designating by the user the order in which print data were printed, after the same document data is printed a plurality of number of times while performing various processes. According to this method, however, the user must remember the order in which print materials were output.

### SUMMARY OF THE INVENTION

The present invention enables realization of an image processing system which improves the operability of repeat printing by allowing the user to designate, by a simple operation, print data to be saved for use in repeat printing, and a control method therefor.

According to one aspect of the present invention there is provided an image processing system having a document reading unit, a printing unit, and a generating unit configured to generate print data used to print by the printing unit, the system comprising: a grouping designation unit configured to group the print data; a storage unit configured to store a plurality of print data grouped by the grouping designation unit; and a specifying unit configured to specify target print data in the storage unit on the basis of a result of reading, by the document reading unit, a printing medium printed by the printing unit on the basis of at least one of the print data.

According to another aspect of the present invention there is provided an image processing system which has a document reading unit, a printing unit, a generating unit configured to generate print data used to print by the printing unit, and a storage unit configured to store a plurality of print data, and can print again using print data stored in the storage unit, the system comprising: a grouping designation unit configured to group the print data; an assigning unit configured to assign, to each print data, identification information including group information for specifying the group and print information for specifying print data in the group; a specifying unit configured to specify target print data in the storage unit on the basis of a result of reading, by the document reading unit, a printing medium printed by the printing unit on the basis of at least one of the print data which are generated by the generating unit and to which the identification information is appended; and a deleting unit configured to delete, from the storage unit except the print data specified by the specifying unit, print data belonging to a group to which the specified print data belongs.

According to another aspect of the present invention there is provided an image forming apparatus having a document reading unit, a printing unit, and a generating unit configured to generate print data used to print by the printing unit, the apparatus comprising: a grouping designation unit configured to group the print data; a storage unit configured to store a plurality of print data grouped by the grouping designation unit; and a specifying unit configured to specify target print data in the storage unit on the basis of a result of reading, by the document reading unit, a printing medium printed by the printing unit on the basis of at least one of the print data.

According to another aspect of the present invention there is provided an image forming apparatus which has a document reading unit, a printing unit, a generating unit configured to generate print data used to print by the printing unit, and a storage unit configured to store a plurality of print data, and can print again using print data stored in the storage unit, the apparatus comprising: a grouping designation unit configured to group the print data; an assigning unit configured to assign, to each print data, identification information including group information for specifying the group and print information for specifying print data in the group; a specifying unit configured to specify target print data in the storage unit on the basis of a result of reading, by the document reading unit, a printing medium printed by the printing unit on the basis of at least one of the print data which are generated by the generating unit and to which the identification information is appended; and a deleting unit configured to delete, from the storage unit except the print data specified by the specifying unit, print data belonging to a group to which the specified print data belongs.

Further features of the present invention will be apparent from the following description of exemplary embodiments with reference to the attached drawings.

### BRIEF DESCRIPTION OF THE DRAWINGS

FIG. 1 is a block diagram showing the configuration of an image processing system according to the first and second embodiments;

FIG. 2 is a block diagram showing the internal arrangement of a printer driver;

FIG. 3 is a flowchart of original print processing according to the first embodiment;

FIGS. 4A and 4B are views each exemplifying a state in which print data are saved;

FIG. 5 is a flowchart of save data finalization processing according to the first embodiment;

FIG. 6 is a flowchart of original print processing according to the second embodiment;

FIG. 7 is a flowchart of save data finalization processing according to the second embodiment; and

FIG. 8 is a view showing a window example of a driver UI according to the first and second embodiments.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

In this specification, the term “printing” (to be also referred to as “print” hereinafter) not only includes the formation of significant information such as characters and graphics, but also broadly includes the formation of images, figures, patterns, and the like on a printing medium, or the processing of the medium, regardless of whether they are significant or insignificant and whether they are so visualized as to be visually perceptible by humans.

Also, the term “printing medium” not only includes paper used in general printing apparatuses, but also broadly includes materials capable of accepting ink, such as cloth, a plastic film, a metal plate, glass, ceramics, wood, and leather.

### First Embodiment

An image processing system comprising a host apparatus and a multi-function peripheral having printer and scanner functions will be exemplified as the first embodiment of an image processing system according to the present invention.

<Configuration of Overall System>

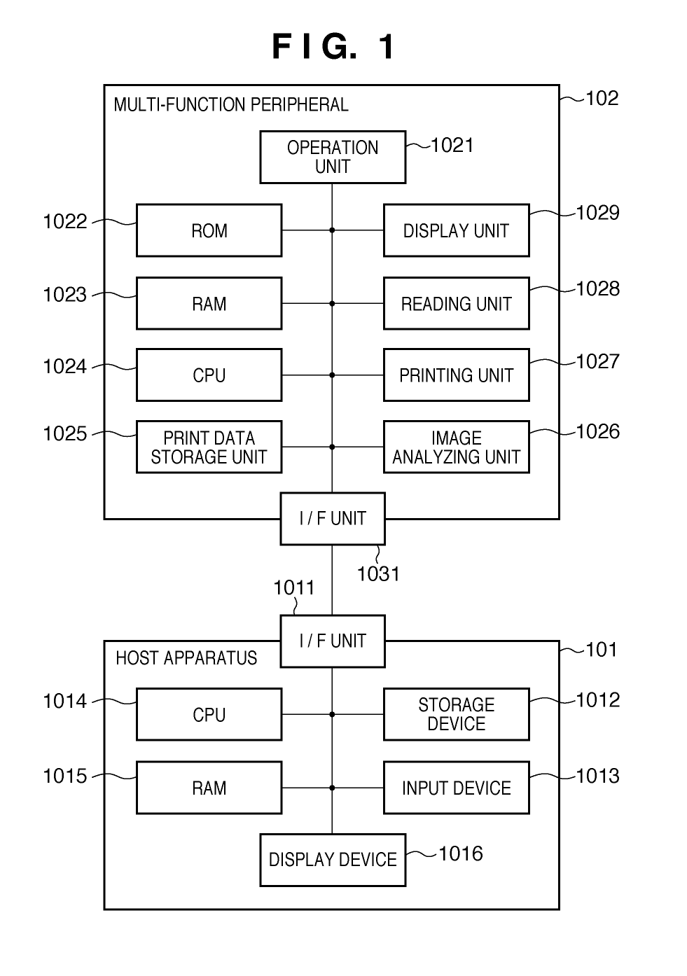

FIG. 1 is a block diagram showing the configuration of the image processing system according to the first embodiment. The image processing system comprises a host apparatus 101 and multi-function peripheral 102. The multi-function peripheral 102 comprises a reading unit 1028 which reads a document to obtain image data, and a printing unit 1027 which prints on a printing medium on the basis of print data sent from the host apparatus 101.

A CPU (Central Processing Unit) 1024 controls the following units. A ROM (Read Only Memory) 1022 stores programs for controlling the reading unit 1028, an image analyzing unit 1026, and the printing unit 1027. A RAM (Random Access Memory) 1023 temporarily stores programs necessary for the operations of the reading unit 1028, image analyzing unit 1026, and printing unit 1027, setting parameters received from the host apparatus 101, and the like.

The reading unit 1028 which reads an image is, e.g., a color scanner. The reading unit 1028 scans a CCD line sensor (not shown) to optically read a document set on the document table and convert the read image into an electrical signal. The electrical signal, i.e., image signal is divided into a plurality of color components such as R, G, and B, and each component is multilevel data of 8 to 16 bits. The printing unit 1027 is, e.g., an inkjet printer, and prints based on print data received from the host apparatus 101.

An interface (I/F) unit 1031 has, e.g., a function of receiving print data from the host apparatus 101, and a function of transmitting the identification number of a read image and a status representing the process status of the multi-function peripheral 102 from the multi-function peripheral 102 to the host apparatus 101. An operation unit 1021 has, e.g., buttons for finalizing print data to be saved from the multi-function peripheral 102, and various buttons used to perform repeat printing. A display unit 1029 displays the status of an operation performed via the operation unit 1021, the setting status of the multi-function peripheral, and the like.

The host apparatus 101 is, e.g., a personal computer (PC), and transmits, to the multi-function peripheral 102, an instruction to control the multi-function peripheral 102, print data, setting commands, and the like.

A CPU (Central Processing Unit) 1014 controls the respective units of the host apparatus 101, and executes control programs such as a printer driver (to be described later). A RAM (Random Access Memory) 1015 ensures a work area for the CPU 1014. A storage device 1012 stores various control programs such as a printer driver.

An input device 1013 includes a keyboard, mouse, and the like for operating the host apparatus 101. A display device 1016 presents a display for confirming information input from the input device 1013, or displays the user interface windows of a printer driver and application, messages, and the like. An interface (I/F) unit 1011 transmits/receives data to/from the multi-function peripheral 102.

<Arrangement of Printer Driver>

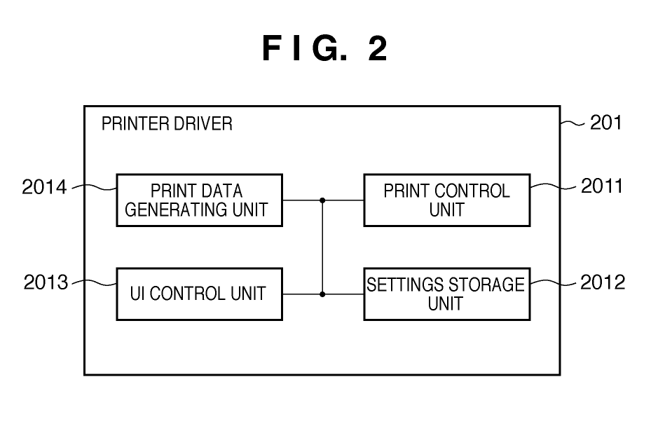

FIG. 2 is a block diagram showing the internal arrangement of the printer driver.

A printer driver 201 is implemented by software, and comprises a print control unit 2011, settings storage unit 2012, UI control unit 2013, and print data generating unit 2014. The CPU 1014 executes the printer driver 201 to achieve control operations and the like by these units.

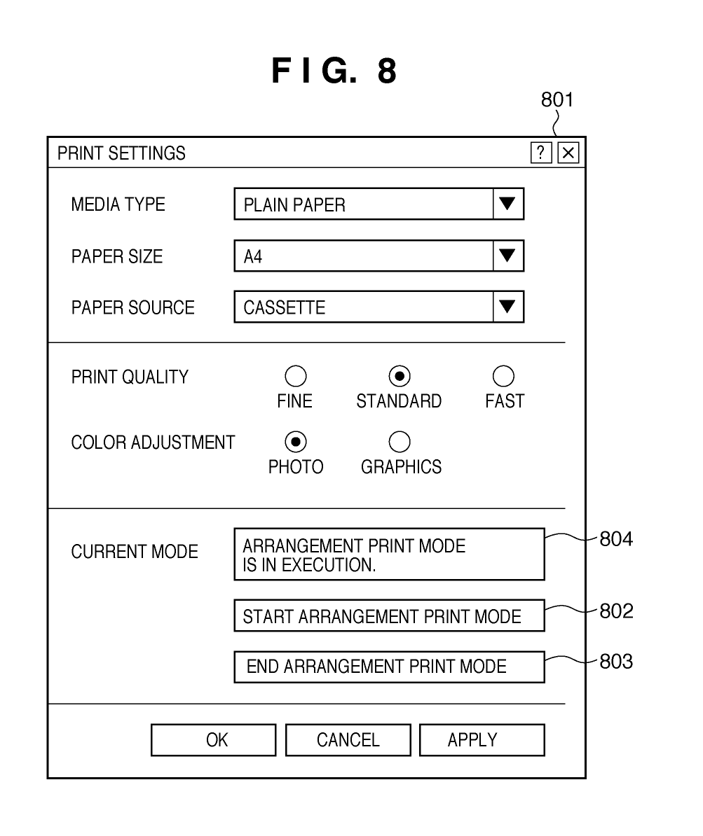

To cause the multi-function peripheral 102 to print, the UI control unit 2013 displays a user interface window (to be referred to as a driver UI hereinafter) to perform control in accordance with a user instruction. FIG. 8 is a view showing a driver UI 801 according to the first embodiment. The user designates various settings in printing (e.g., the type and size of paper serving as a printing medium, the paper source, and color adjustment) via the driver UI 801 displayed on the display device 1016 under the control of the UI control unit 2013. The UI control unit 2013 stores these pieces of setting information in the settings storage unit 2012.

As a function of the printer driver 201, an “arrangement print mode” is adopted to continuously print while changing the type of output image by processing the same document in various ways. The driver UI 801 has an arrangement print mode start button 802 as a setting item to start the arrangement print mode. The UI control unit 2013 stores, in the settings storage unit 2012 as one item of print setting information, whether the user has pressed the arrangement print mode start button 802. When printing continues until the user presses an arrangement print mode end button 803 to end the arrangement print mode after pressing the arrangement print mode start button 802, processing (to be described later) to finalize data to be saved after saving a print data group is executed. When the multi-function peripheral 102 is in the arrangement print mode, the UI control unit 2013 presents, in a mode display area 804 on the driver UI 801, a display which notifies the user that the multi-function peripheral 102 is in the arrangement print mode. The user can manipulate the arrangement print mode button only when the multi-function peripheral 102 is in the arrangement print mode.

The settings storage unit 2012 stores identification information for specifying print data from a print material in the arrangement print mode. The identification information is determined by a combination of group information and print information. The group information is a number for identifying print data which have been generated in the same arrangement print mode and are designated to be grouped by saving them as the same group. The group information is used to specify a group. Print data having the same group information are to be deleted at once in save data finalization processing (to be described later). The print information is a number which differs between print data in order to identify each print data among print data of the same group having the same group information. All print data having the same group information have different pieces of print information. By assigning identification information serving as a combination of group information and print information, print data saved in a print data storage unit 1025 can be specified.

The settings storage unit 2012 further stores group information M, print information P, and an arrangement print mode flag F which have been obtained at the end of previous printing. The arrangement print mode flag F is used to determine whether the multi-function peripheral 102 is in the arrangement print mode now. F=1 represents that the peripheral is in the arrangement print mode, and F=0 represents that the peripheral is not in the arrangement print mode. The printer driver 201 stores the value of the arrangement print mode flag F in the settings storage unit 2012 every time a print job ends. The F value is rewritten into 0 when the multi-function peripheral 102 transmits an arrangement print mode end notification in save data finalization processing (to be described later) or when the user presses the arrangement print mode end button 803 on the driver UI 801.

When the user designates execution of printing via the driver UI 801, the print data generating unit 2014 generates print data in a data format printable by the printing unit 1027 in accordance with settings stored in the settings storage unit 2012. At this time, the print data generating unit 2014 performs processes such as rasterization, color conversion, and command appending for data such as image data and a graphic rendering instruction obtained from an application. The application is software running on an operating system serving as the basic software of the host apparatus 101. The application has a function of printing created data. Examples of the application are word processing software for creating a document, image editing software, and New Year's card creation software.

The print control unit 2011 controls printing by transmitting print data generated by the print data generating unit 2014 to the multi-function peripheral. The print control unit 2011 also obtains data such as a status transmitted from the multi-function peripheral.

<Processing Sequence When Executing Original Printing>

(Processing by Driver When Executing Original Printing)

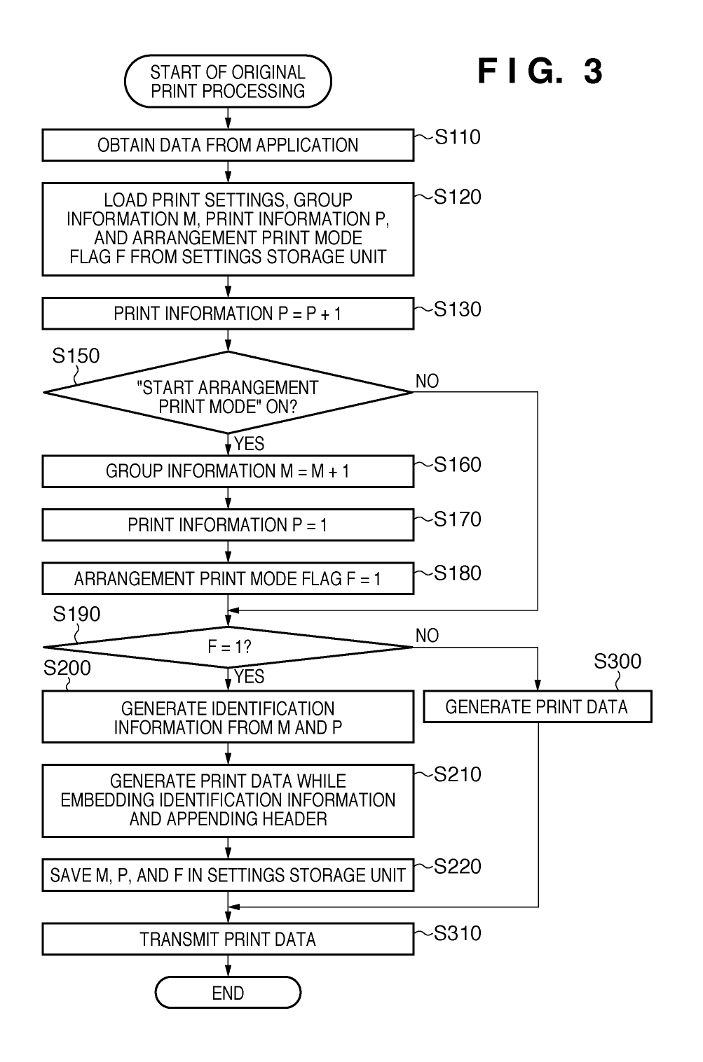

FIG. 3 shows the operation sequence of the printer driver in processing (to be referred to as original print processing hereinafter) to print, via the printer driver, document data created by an application or the like in the image processing system according to the first embodiment. As described above, the CPU 1014 executes the printer driver 201 to achieve the following steps.

When the user selects the multi-function peripheral 102 from an application to execute print processing, the printer driver 201 of the selected multi-function peripheral 102 is activated. When the user designates execution of print processing via the driver UI 801, original print processing shown in FIG. 3 starts. The settings storage unit 2012 stores the contents of settings made on the driver UI 801.

In step S110, the print control unit 2011 of the printer driver 201 obtains data such as image data and a graphic rendering instruction from the application. In step S120, the print data generating unit 2014 of the printer driver 201 loads print setting information, the group information M, the print information P, and the arrangement print mode flag F from the settings storage unit 2012. The settings storage unit 2012 stores the group information M, print information P, and arrangement print mode flag F which have been obtained at the end of previous printing. Note that the value of the group information M is initialized to M=1 when the printer driver 201 is stored (installed) in the storage device 1012 of the host apparatus 101. The F value is rewritten into 0 when the multi-function peripheral 102 transmits a mode end notification in save data finalization processing (to be described later) or when the user presses the arrangement print mode end button 803 on the driver UI 801.

In step S130, the printer driver 201 increments the print information P (P=P+1), and generates print information representing the current print processing. In step S150, the printer driver 201 determines, based on print settings loaded from the settings storage unit 2012, whether the user has designated “start the arrangement print mode”. If the user has not designated “start the arrangement print mode”, the process advances to step S190. If the user has designated “start the arrangement print mode”, the process advances to step S160 to increment the group information M (M=M+1) and generate new group information. In step S170, the printer driver 201 sets the print information P=1. That is, P is reset to 1 to represent the first print processing for the new group information after the group information M stored in the settings storage unit is incremented by one in order to identify a new print data group along with the new start of the arrangement print mode. In step S180, the printer driver 201 sets the arrangement print mode flag F=1, and stores, in the settings storage unit 2012, information that the multi-function peripheral 102 is in the arrangement print mode.

In step S190, the printer driver 201 determines, from the F value, whether the multi-function peripheral 102 is in the arrangement print mode now. If F=0, the printer driver 201 determines that the peripheral is not in the arrangement print mode, and advances to step S300. In step S300, the print data generating unit 2014 of the printer driver 201 generates print data on the basis of the loaded print settings. At this time, neither embedding of identification information in print data nor appending of header information, which will be described later, is performed.

If F=1 in step S190 and the printer driver 201 determines that the peripheral is in the arrangement print mode, the process advances to print data group save processing in steps S200 to S220. In step S200, the printer driver 201 generates print data identification information from the group information M and print information P. The identification information is “group information-print information” made up of group information for specifying an arrangement print mode in which print data have been printed, i.e., a print data group to which the print data belong, and print information for specifying each print data in the group. For example, when the group information M=0003 and the print information P=0011, the identification information is “0003-0011”.

In step S210, the print data generating unit 2014 of the printer driver 201 generates print data on the basis of the loaded print settings. At this time, the identification information generated in step S200 is embedded in print data using a general digital watermark technique. Further, the identification information is appended as header information to the head of the print data in order to specify print data to be saved and print data to be deleted in save data finalization processing (to be described later). In step S220, the printer driver 201 saves the current group information M, print information P, and arrangement print mode flag F in the settings storage unit 2012.

In step S310, the print control unit 2011 of the printer driver 201 sends the print data to the multi-function peripheral 102. Then, this sequence ends.

(Processing by Printer When Executing Original Printing)

Upon receiving print data from the host apparatus 101, the multi-function peripheral 102 forms an image on a printing medium on the basis of the print data. The multi-function peripheral 102 saves the print data in the print data storage unit 1025.

For example, when the multi-function peripheral 102 is in the arrangement print mode, the process in step S210 is performed. Thus, identification information is embedded as a digital watermark in image data, and the same identification information is also appended to the header of print data sent to the multi-function peripheral 102. Hence, the identification information is invisibly printed on an output print material. The print data storage unit 1025 stores the print data in which the same identification information is appended as header information.

<Example of Operation by User in Arrangement Printing>

Processing when the user continuously prints using the arrangement print mode on the basis of the above-described sequence will be explained. A case where the user performs twelve printing operations while finely adjusting the design using an application will be exemplified.

The user creates the first design on an application and prints it. At this time, to start arrangement printing of continuously printing while processing the same document in various ways, the user presses the arrangement print mode start button 802 on the driver UI 801 in printing, and designates execution of printing. Then, the printer driver 201 determines in step S150 in the flowchart of FIG. 3 that the arrangement print mode has started, and performs processes in step S160 to S180. In this case, assume that M=0023 in step S160, and P=0001 in step S170. In step S180, F=1. Since F=1, the printer driver 201 determines in step S190 that the multi-function peripheral 102 is in the arrangement print mode, and performs print data group save processing in steps S200 to S220. The printer driver 201 generates identification information “0023-0001” in step S200, and generates print data in step S210 by embedding the identification information “0023-0001” in an image using the digital watermark technique. Further, the printer driver 201 appends the same identification information to the header of the print data. In step S220, the printer driver 201 saves M=0023, P=0001, and F=1 in the settings storage unit 2012. In step S310, the printer driver 201 transmits the print data to the multi-function peripheral 102, and ends the print processing.

Based on the received print data, the printing unit 1027 of the multi-function peripheral 102 forms an image on a printing medium. The print data storage unit 1025 saves the print data. At this time, the identification information “0023-0001” is invisibly printed on the print material.

Then, the user changes the layout of an image and text on the application, and prints again. At this time, the arrangement print mode has already started, so the user designates execution of printing without pressing the arrangement print mode start button 802 on the driver UI 801.

In response to this, the printer driver 201 advances from step S150 to step S190. Since F=1 in the first print processing, the printer driver 201 determines in step S190 that the multi-function peripheral 102 is in the arrangement print mode, and advances to print data group save processing in steps S200 to S220. Since the processes in steps S160 and S170 are not performed, identification information generated in step S200 is “0023-0002”. Subsequent processing and the processing of the multi-function peripheral 102 are the same as those in the first print processing.

Similarly in the same arrangement print mode, the user further performs 10 print operations while executing various processes on the application and changing print settings on the driver UI. Then, print materials on which pieces of identification information “0023-0003” to “0023-0012” are printed are output, and corresponding print data are accumulated in the print data storage unit 1025.

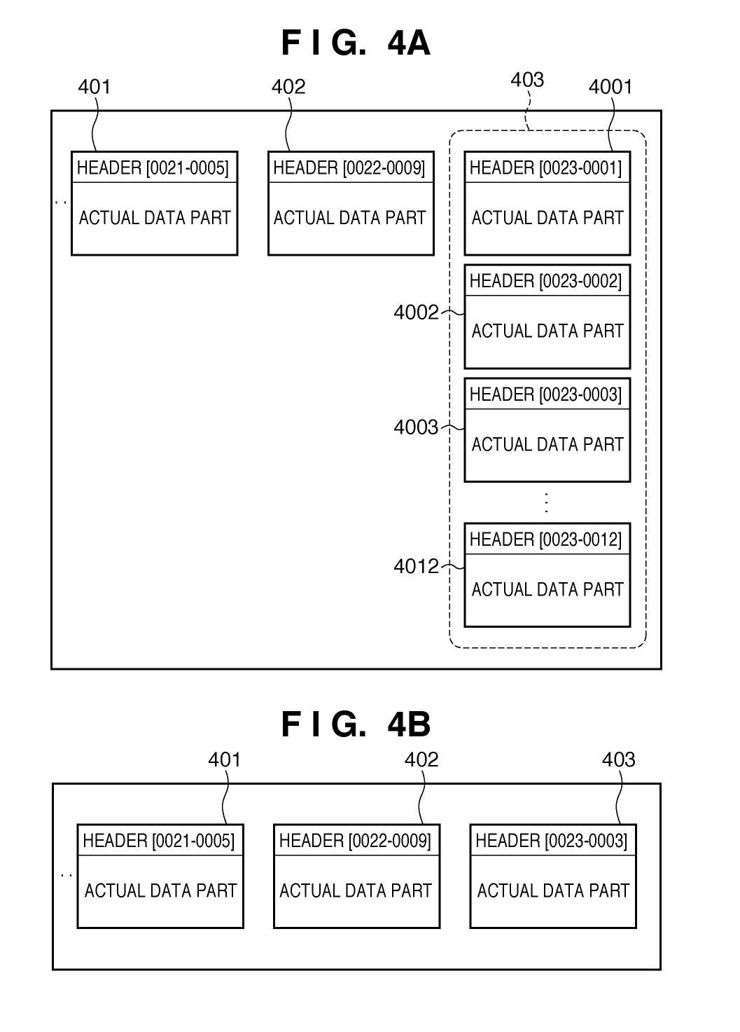

FIG. 4A is a view exemplifying a state in which print data are saved in the print data storage unit 1025. Print data surrounded by a broken line 403 in FIG. 4A are print data accumulated by the series of print processes described above. Print data 401 and 402 are those which have been printed in the arrangement print mode and saved as a result of executing save data finalization processing (to be described later).

<Sequence When Executing Save Data Finalization Processing>

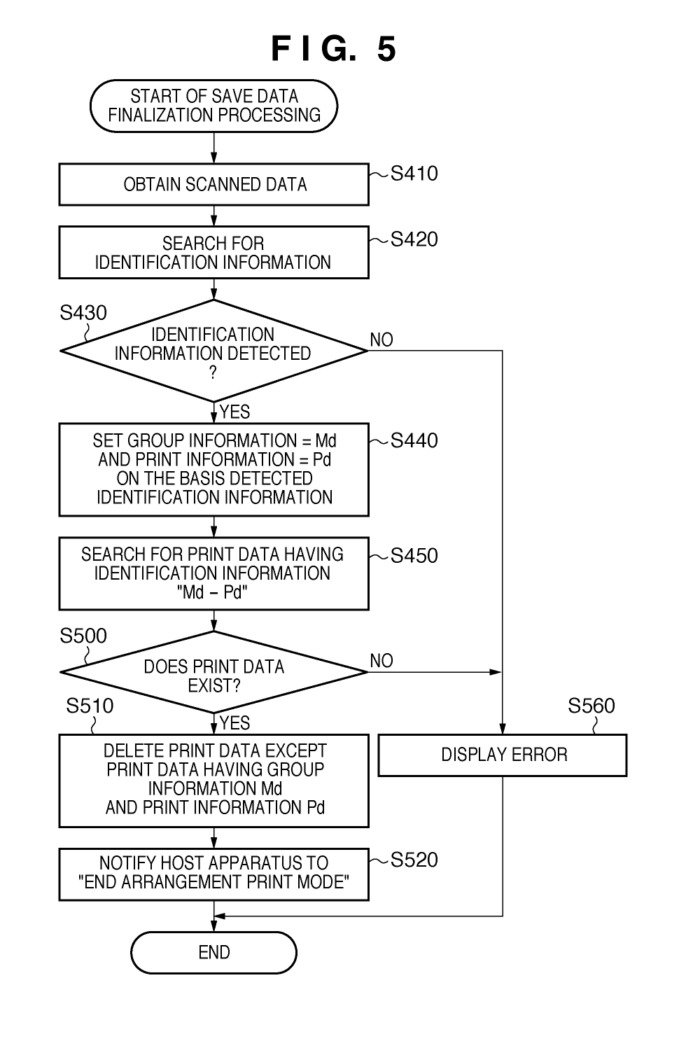

FIG. 5 is a flowchart of the operation of the multi-function peripheral 102 in save data finalization processing according to the first embodiment.

After a series of print processes ends, the user selects a print material whose print data is to be saved for repeat printing, and scans the selected print material by the reading unit 1028 of the multi-function peripheral 102. At this time, the user designates scanning of the print material by pressing a save data finalization button (not shown) on the operation unit 1021 of the multi-function peripheral 102. The multi-function peripheral 102 accepts a save data finalization processing instruction in response to press of the save data finalization button, and starts the process shown in FIG. 5.

In step S410, the reading unit 1028 of the multi-function peripheral 102 scans under the control of the CPU 1024, and sends the scanned data to the image analyzing unit 1026. In step S420, the image analyzing unit 1026 of the multi-function peripheral 102 searches for identification information embedded as a digital watermark in the scanned data. In step S430, the multi-function peripheral 102 determines whether the identification information has been detected in step S420. If no identification information has been detected, the process advances to step S560, and the multi-function peripheral 102 displays, on the display unit 1029, an error representing that the save data finalization processing has failed. Then, this sequence ends.

If identification information has been detected in step S430, the process advances to step S440. In step S440, the multi-function peripheral 102 executes a process to set the group information of the detected identification information to Md and the print information to Pd. In step S450, the multi-function peripheral 102 searches the print data storage unit 1025 for print data in which the identification information “Md—Pd” is appended to the header. In step S500, the multi-function peripheral 102 determines whether the target print data exists in the print data storage unit 1025. If no target print data exists, the process advances to step S560.

If the target print data exists in step S500, the process advances to step S510. In step S510, the multi-function peripheral 102 deletes, from the print data storage unit 1025, print data for which group information of identification information is Md and print information is not Pd, among print data accumulated in the print data storage unit 1025. As a result, print data capable of providing a print material designated by the user via the save data finalization button remains, and the remaining print data accumulated in the same arrangement print mode are deleted.

In step S520, the multi-function peripheral 102 notifies the printer driver 201 of the host apparatus 101 that it is no longer in the arrangement print mode. Upon receiving the arrangement print mode end notification, the printer driver 201 rewrites the arrangement print mode flag F stored in the settings storage unit 2012 into 0. The settings storage unit 2012 stores a state in which the multi-function peripheral 102 is not in the arrangement print mode.

FIG. 4B is a view exemplifying a state in which print data are saved in the print data storage unit 1025 after performing save data finalization processing in the state of FIG. 4A using a print material on which identification information “0023-0003” is printed. As shown in FIG. 4B, all print data having group information “0023” are deleted except print data having print information “0003”.

Note that a case where the user designates deletion of print data with the save data finalization button has been exemplified. However, the present invention is not limited to this method, and may also adopt the following configuration. That is, when the user designates scanning via a general scan button attached to the multi-function peripheral, identification information is always searched for. If identification information is detected, other print data having the same group information as that of a print material but different print information are deleted.

As described above, the image processing system according to the first embodiment can improve the operability of repeat printing. More specifically, a series of print data obtained when continuously printing the same document while processing it in various ways are saved together with the same group information. This makes it possible to delete print data obtained by a series of print operations except print data corresponding to a designated print material. When executing repeat printing, the user can select print data to be output again from print data determined by the user to be able to provide a preferable print material. As a result, the operability of repeat printing can be improved.

### Second Embodiment

An image processing system according to the second embodiment is identical to the image processing system (FIG. 1) according to the first embodiment except that an optical sensor (to be referred to as a sheet sensor hereinafter) is arranged at the paper feed port (not shown) of a printing unit 1027 to read part of a sheet serving as a printing medium. The sheet sensor operates under the control of the print control unit of a printer driver 201. The second embodiment uses a sheet on which a unique sheet number and a barcode representing it are printed in advance in a specific area (to be referred to as a barcode area hereinafter) on the lower surface in order to uniquely specify each sheet. In the second embodiment, identification information for specifying print data to be saved and print data to be deleted is generated from a combination of group information and the sheet number.

Processing Sequence When Executing Original Printing>

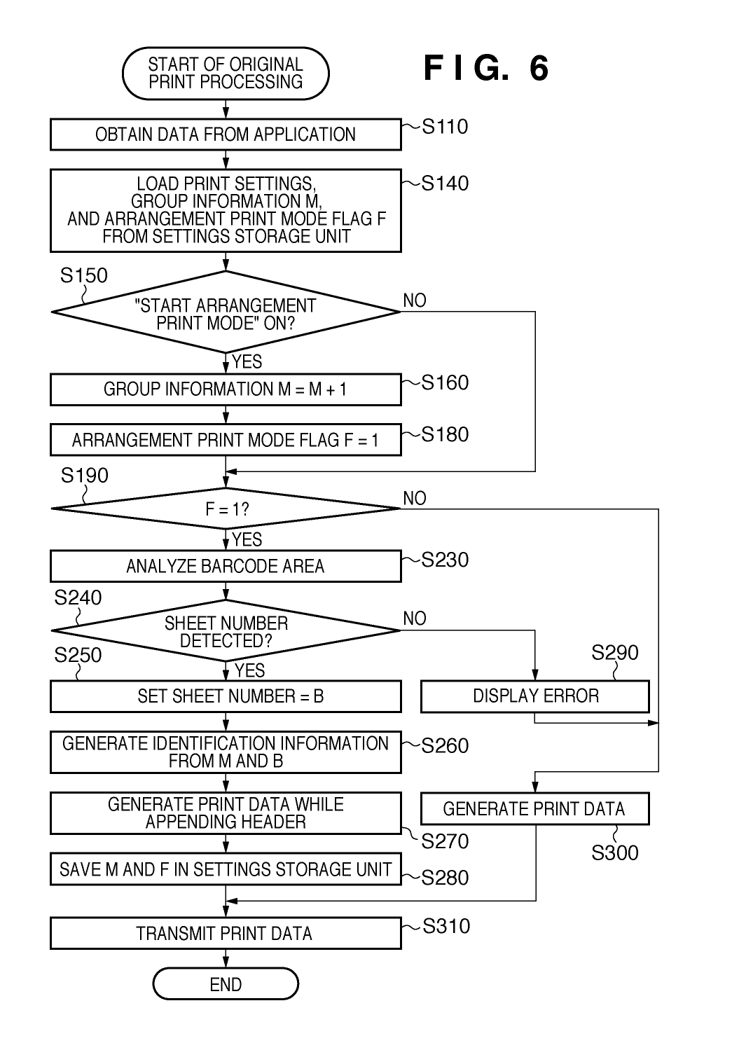

FIG. 6 shows the operation sequence of the printer driver 201 in original print processing according to the second embodiment. The arrangement of the printer driver 201 and a driver UI 801 are the same as those in the first embodiment. A detailed description of steps common to the operation sequence (FIG. 3) of the printer driver 201 in original print processing according to the first embodiment will not be repeated.

Step S110 is common to that in the first embodiment, so a description thereof will not be repeated. In step S140, a print data generating unit 2014 of the printer driver 201 loads print setting information, group information M, and an arrangement print mode flag F from a settings storage unit 2012. The group information M and arrangement print mode flag F are the same as those in the first embodiment. In the second embodiment, the settings storage unit 2012 stores the group information M and arrangement print mode flag F which have been obtained at the end of previous printing.

Steps S150 to S190 are the same as those in the first embodiment except that no print information is set.

If F=0 in step S190, the printer driver 201 advances to step S300. If F=1, the printer driver 201 determines that a multi-function peripheral 102 is in the arrangement print mode, and advances to print data group save processing in steps S230 to S280. In step S230, the printer driver 201 issues an instruction to the multi-function peripheral 102 to analyze the barcode area of a sheet, and tires to obtain a sheet number from the multi-function peripheral 102. Upon receiving the barcode area analysis instruction, the multi-function peripheral 102 controls the sheet sensor to read the barcode area on the lower surface of a sheet set at the paper feed port. The multi-function peripheral 102 transmits the detection result to a host apparatus 101.

In step S240, the printer driver 201 determines whether the sheet number has been detected. If no sheet number has been detected, the printer driver 201 displays an error to this effect in step S290, and generates print data in step S300.

If the sheet number has been detected in step S240, the process advances to step S250 to set the sheet number to B. In step S260, the printer driver 201 generates print data identification information from the group information M and sheet number B. The identification information in the second embodiment is “group information-sheet number” made up of group information for specifying an arrangement print mode in which print data have been printed, i.e., a print data group to which the print data belong, and a sheet number capable of uniquely specifying a sheet. Similar to the first embodiment, print materials generated in the same arrangement print mode have the same group information. Further, a sheet number capable of uniquely specifying a sheet can be used to specify print data to be deleted in save data finalization processing (to be described later).

In step S270, the printer driver 201 generates print data on the basis of the loaded print settings. At this time, the identification information generated in step S260 is appended as header information to the head of the print data. In step S280, the printer driver 201 saves the current group information M and arrangement print mode flag F in the settings storage unit 2012.

Step S310 is the same as that in the first embodiment.

The operation of the multi-function peripheral 102 upon receiving print data is the same as that in the first embodiment. However, the second embodiment does not perform processing to append identification information as a digital watermark to print data, so no identification information is printed on a print material.

<Sequence When Executing Save Data Finalization Processing>

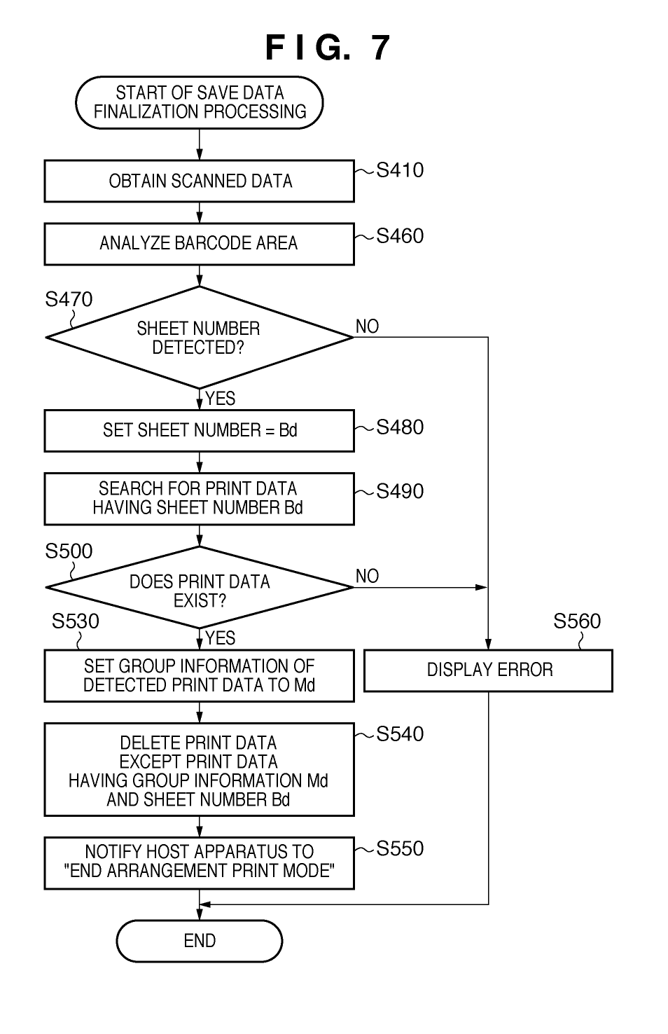

FIG. 7 is a flowchart of the operation of the multi-function peripheral 102 in save data finalization processing according to the second embodiment. A detailed description of steps common to the sequence (FIG. 5) when executing save data finalization processing according to the first embodiment will not be repeated.

After a series of print processes ends, the user selects a print material whose print data is to be saved for repeat printing, and scans the lower surface of the selected print material by a reading unit 1028 of the multi-function peripheral 102. Similar to the first embodiment, the multi-function peripheral 102 accepts a save data finalization processing instruction in response to press of the save data finalization button, and starts the process shown in FIG. 7.

Step S410 is common to that in the first embodiment, so a description thereof will not be repeated. In step S460, an image analyzing unit 1026 of the multi-function peripheral 102 analyzes scanned data of the barcode area, and searches for a sheet number. In step S470, the multi-function peripheral 102 determines whether the sheet number has been detected in step S460. If no sheet number has been detected, the process advances to step S560; if the sheet number has been detected, to step S480. In step S480, the multi-function peripheral 102 sets the detected sheet number to Bd. In step S490, the multi-function peripheral 102 searches a print data storage unit 1025 for print data in which the sheet number Bd is appended to the header. In step S500, the multi-function peripheral 102 determines whether the target print data exists in the print data storage unit 1025. If no target print data exists, the process advances to step S560.

If the target print data exists in step S500, the process advances to step S530. In step S530, the multi-function peripheral 102 obtains group information of the print data from header information of the print data detected in step S490, and sets the group information to Md. In step S540, the multi-function peripheral 102 deletes, from the print data storage unit 1025, print data for which group information of identification information is Md and the sheet number is not Bd, among print data accumulated in the print data storage unit 1025. As a result, print data capable of providing a print material designated by the user via the “save data finalization button” remains, and the remaining print data accumulated in the same arrangement print mode are deleted.

In step S550, the multi-function peripheral 102 notifies the printer driver 201 of the host apparatus 101 that it is no longer in the arrangement print mode. The process of the printer driver 201 upon receiving the mode end notification is the same as that in the first embodiment.

In the above-described example, the user scans a barcode on the lower surface of a sheet to designate print data to be held for repeat printing in save data finalization processing. However, the present invention is not limited to this method, and may also adopt the following configuration. That is, an operation unit 1021 comprises a ten-key pad. The user inputs a sheet number printed on the lower surface of a sheet together with a barcode, thereby designating print data of a print material to be saved. This configuration can implement an image processing system using a printer having no scanner function.

As described above, the image processing system according to the second embodiment can improve the operability of repeat printing. More specifically, the same group information is assigned to a series of print data obtained when continuously printing the same document while processing it in various ways. Further, a unique sheet number capable of specifying a sheet is detected from a sheet, and combined with the group information into identification information. The identification information is assigned to print data and saved. This allows deleting print data obtained by a series of print operations except print data corresponding to a designated print material. When executing repeat printing, the user can select print data to be output again from print data determined by the user to be able to provide a preferable print material. Accordingly, the operability of repeat printing can be improved. Since no identification information need be printed on a print material, the load of print data generation processing reduces. In addition, a configuration in which the user inputs a sheet number can implement an image processing system using a printer having no scanner function.

In the above-described embodiments, document printing (original printing) is executed using the printer driver from the host apparatus, and repeat printing is executed based on print data saved in the internal storage device of the multi-function peripheral. However, original printing may also be directly performed from the multi-function peripheral. For example, the multi-function peripheral may also comprise a memory card slot. In this case, various memory cards are inserted into the memory card slot, and printing is done based on image data stored in the memory cards. Print data can also be saved not in the storage area of the multi-function peripheral but in the internal storage area of the host apparatus.

In the above-described example, print data is saved in a data format processible by the printer, and designated print data is directly output in repeat printing. However, data to be saved may also be document data created by an application. For example, processing information obtained when the application processes document data, and print setting information set by the printer driver in printing are saved in association with document data. Similar to the embodiments, identification information is appended and saved. In repeat printing, designated data is output again after performing the same processing at the same print settings as those in original printing. Consequently, repeat printing similar to original printing can be achieved.

In save data finalization processing, only one print material is designated. However, the configuration may also allow the user to designate a plurality of print data to be saved. For example, the following configuration allows the user to designate save of a plurality of print data.

For example, in save data finalization processing, the user sets a plurality of print materials on the document table, and presses the save data finalization button. The multi-function peripheral performs so-called multi-crop processing to individually crop the plurality of print materials on the document table. The multi-function peripheral detects identification information from each of the cropped print materials. The multi-function peripheral saves print data corresponding to all pieces of detected identification information, and deletes the remaining print data having the same group information.

In another example, when the user presses the save data finalization button, identification information is detected from scanned data, and a dialog is displayed to confirm with the user whether there is another data to be saved. Scanning of a print material and detection of identification information are repeated until the user notifies, by an operation via the dialog, the end of designating print data to be saved. After the user notifies the end of designating print data to be saved, print data are deleted except those having the detected identification information.

In the above-described embodiments, identification information is generated by combining group information, and print information or a sheet number, and the group of print data is specified by the group information. However, a method of specifying a group is not limited to this. For example, identification information is formed from numbers unique to all print data without having information for specifying a group. When the start and end of each group are designated, identification information of print data corresponding to the start or end of a group is stored in a memory or the like, and managed as a group information management table. In save data finalization processing, a group containing identification information of a designated print material is specified from the group information management table, and print data belonging to the group are deleted except designated print data.

Information representing that save of print data has been finalized may also be appended to print data designated to be saved. In this case, in save data finalization processing, all print data can also be deleted except designated print data, and print data designated to be saved in previous save data finalization processing. That is, in save data finalization processing, print data is specified from identification information of a designated print material, and information representing that save of data has been finalized is appended to the specified print data. Then, all print data having no information representing that save of data has been finalized are deleted. In this manner, print data can be deleted except print data designated in save data finalization processing, and print data designated to be saved in previous save data finalization processing. This configuration obviates the need to manage print data for each group. The user need not designate the start of the mode with the arrangement print mode start button in original printing. Hence, no print data need be managed for each group using group information, the above-mentioned group information management table, or the like.

The present invention may also be applied to a system including a plurality of devices, or an apparatus formed by a single device.

The present invention is also achieved by supplying a program for implementing the functions of the above-described embodiments to a system or apparatus directly or from a remote place, and reading out and executing the supplied program codes by the system or apparatus. Hence, the program codes installed in the computer to implement the functions of the present invention by activating the computer also fall within the technical scope of the present invention.

In this case, the program is arbitrary such as an object code, a program executed by an interpreter, or script data supplied to an OS as long as the functions of the program can be provided.

Examples of the storage medium for supplying the program are a flexible disk, hard disk, optical disk (CD and DVD), magneto-optical disk, magnetic tape, nonvolatile memory card, and ROM.

The functions of the above-described embodiments are implemented when the computer executes the readout program codes. The functions of the above-described embodiments can also be implemented when an OS or the like running on the computer performs part or all of actual processing on the basis of the instructions of the program.

The functions of the above-described embodiments are also implemented by the following processing. That is, the program read out from the recording medium is written in the memory of a function expansion board inserted into the computer or the memory of a function expansion unit connected to the computer. Then, the CPU of the function expansion board or function expansion unit performs part or all of actual processing on the basis of the instructions of the program.

According to the present invention, the user can designate, by a simple operation, print data to be saved in a storage device. The user can easily select data to be output again in repeat printing, and the operability of repeat printing can be improved. Since print data not subjected to repeat printing is deleted, the storage area can be effectively used.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-223092 filed on Aug. 29, 2007, which is hereby incorporated by reference herein in its entirety.

What is claimed is:

1. An image processing system having a document reading unit, a printing unit, and a generating unit configured to generate print data used to print by the printing unit, the system comprising:
a grouping designation unit configured to group the print data;
a storage unit configured to store a plurality of print data grouped by the grouping designation unit; and
a specifying unit configured to specify target print data in the storage unit on the basis of a result of reading, by the document reading unit, a printing medium printed by the printing unit on the basis of at least one of the print data.

2. The system according to claim 1, further comprising an assigning unit configured to assign, to each print data, identification information including group information for specifying the group and print information for specifying print data in the group,
wherein the storage unit stores the identification information together with the print data,
the printing unit appends the identification information to the print data and prints, and
the specifying unit specifies the print data on the basis of the identification information.

3. An image processing system which has a document reading unit, a printing unit, a generating unit configured to generate print data used to print by the printing unit, and a storage unit configured to store a plurality of print data, and can print again using print data stored in the storage unit, the system comprising:
a grouping designation unit configured to group the print data;
an assigning unit configured to assign, to each print data, identification information including group information for specifying the group and print information for specifying print data in the group;
a specifying unit configured to specify target print data in the storage unit on the basis of a result of reading, by the document reading unit, a printing medium printed by the printing unit on the basis of at least one of the print data which are generated by the generating unit and to which the identification information is appended; and
a deleting unit configured to delete, from the storage unit except the print data specified by the specifying unit, print data belonging to a group to which the specified print data belongs.

4. The system according to claim 3, wherein
a sheet number for specifying a medium is assigned in advance to the printing medium,
the image processing system further comprises an obtaining unit configured to obtain the sheet number, and
the assigning unit assigns the sheet number obtained by the obtaining unit as the print information.

5. A method of controlling an image processing system having a document reading unit, a printing unit, and a generating unit configured to generate print data used to print by the printing unit, the method comprising:
grouping the print data;
storing a plurality of print data grouped in grouping the print data in a storage unit; and
specifying target print data in the storage unit on the basis of a result of reading, by the document reading unit, a printing medium printed by the printing unit on the basis of at least one of the print data.

6. A method of controlling an image processing system which has a document reading unit, a printing unit, a generating unit configured to generate print data used to print by the printing unit, and a storage unit configured to store a plurality of print data, and can print again using print data stored in the storage unit, the method comprising:
grouping the print data;
assigning, to each print data, identification information including group information for specifying the group and print information for specifying print data in the group;
specifying target print data in the storage unit on the basis of a result of reading, by the document reading unit, a printing medium printed by the printing unit on the basis of at least one of the print data which are generated by the generating unit and to which the identification information is appended; and
deleting, from the storage unit except the print data specified in specifying target print data, print data belonging to a group to which the specified print data belongs.

7. An image forming apparatus having a document reading unit, a printing unit, and a generating unit configured to generate print data used to print by the printing unit, the apparatus comprising:
a grouping designation unit configured to group the print data;
a storage unit configured to store a plurality of print data grouped by the grouping designation unit; and
a specifying unit configured to specify target print data in the storage unit on the basis of a result of reading, by the document reading unit, a printing medium printed by the printing unit on the basis of at least one of the print data.

8. An image forming apparatus which has a document reading unit, a printing unit, a generating unit configured to generate print data used to print by the printing unit, and a storage unit configured to store a plurality of print data, and can print again using print data stored in the storage unit, the apparatus comprising:
a grouping designation unit configured to group the print data;
an assigning unit configured to assign, to each print data, identification information including group information for specifying the group and print information for specifying print data in the group;
a specifying unit configured to specify target print data in the storage unit on the basis of a result of reading, by the document reading unit, a printing medium printed by the printing unit on the basis of at least one of the print data which are generated by the generating unit and to which the identification information is appended; and
a deleting unit configured to delete, from the storage unit except the print data specified by the specifying unit, print data belonging to a group to which the specified print data belongs.

9. A method of controlling an image forming apparatus having a document reading unit, a printing unit, and a generating unit configured to generate print data used to print by the printing unit, the method comprising:
grouping the print data;
storing a plurality of print data grouped in grouping the print data in a storage unit; and
specifying target print data in the storage unit on the basis of a result of reading, by the document reading unit, a printing medium printed by the printing unit on the basis of at least one of the print data.

10. A method of controlling an image forming apparatus which has a document reading unit, a printing unit, a generating unit configured to generate print data used to print by the printing unit, and a storage unit configured to store a plurality of print data, and can print again using print data stored in the storage unit, the method comprising:
grouping the print data;
assigning, to each print data, identification information including group information for specifying the group and print information for specifying print data in the group;
specifying target print data in the storage unit on the basis of a result of reading, by the document reading unit, a printing medium printed by the printing unit on the basis of at least one of the print data which are generated by the generating unit and to which the identification information is appended; and
deleting, from the storage unit except the print data specified in specifying target print data, print data belonging to a group to which the specified print data belongs.

11. A computer-readable storage medium storing a computer program which causes an image forming apparatus to execute steps in claim 9.

12. A computer-readable storage medium storing a computer program which causes an image forming apparatus to execute steps in claim 10.
